(19) United States
(12) Patent Application Publication
(10) Pub. No.: US 2023/0246518 A1
(43) Pub. Date: Aug. 3, 2023

(54) ROTOR SHAFT FOR A ROTOR OF AN ELECTRIC MACHINE AS WELL AS ROTOR AND ELECTRIC MACHINE

(71) Applicant: Mahle International GmbH, Stuttgart (DE)

(72) Inventors: Patrick Altherr, Stuttgart (DE); Christoph Steinmetz, Ludwigsburg (DE)

(21) Appl. No.: 18/105,240

(22) Filed: Feb. 2, 2023

(30) Foreign Application Priority Data
Feb. 3, 2022 (DE) 10 2022 201 134.1

(51) Int. Cl. H02K 7/00; H02K 7/08; H02K 1/28

(52) U.S. Cl. CPC H02K 7/003; H02K 7/085; H02K 1/28

(57) ABSTRACT

A rotor shaft for a rotor of an electric machine is disclosed. The rotor shaft includes a hollow-cylindrical tubular body surrounding a tubular body interior that is open at least on one of its two front sides. A front-side opening defined by the tubular body on the at least one front side is closed via a bearing element that is non-rotatably connected to the tubular body. An annular support body is arranged radially on an outer circumferential side of the tubular body and non-rotatably connected to the tubular body. The support body supports itself axially on a front side of the bearing element facing the tubular body.

### CROSS-REFERENCE TO RELATED APPLICATION

This application claims priority to German Application No. DE 10 2022 201 134.1 filed on Feb. 3, 2022, the contents of which are hereby incorporated by reference in its entirety.

### TECHNICAL FIELD

The invention relates to a rotor shaft for a rotor of an electric machine as well as to a rotor having such a rotor shaft. In addition, the invention relates to an electric machine having such a rotor.

### BACKGROUND

Usually, a laminated rotor core is non-rotatably joined to a rotor shaft of an electric machine, by means of which laminated rotor core the field line pattern of the magnetic field formed between rotor and stator can be influenced and thus also optimised.

Since the rotor sheets of the laminated rotor core typically have a low sheet thickness, i.e. are formed thin-walled, a simple, mechanically stable yet precise non-rotatable mounting of the rotor sheets, such as is required for optimally influencing the magnetic field line pattern, proves to be problematic. This is true in particular for positively or non-positively connecting the bearing element to a tubular body forming the actual rotor shaft.

It is therefore an object of the present invention to create an improved embodiment for a rotor shaft which addresses the problem mentioned above.

This object is solved through the subject of the independent patent claim(s). Preferred embodiments are subject of the dependent patent claims.

### SUMMARY

Accordingly, the basic idea of the present invention is to arrange, on a rotor shaft for a rotor of an electric machine, an annular support body which supports itself both on a tubular body of the rotor shaft and also on a bearing element extending the tubular body axially on the inside for rotatably mounting the rotor shaft. By means of the support body, surface impairments created during the non-rotatable joining of the bearing element can be covered and modifications in the geometry of tubular body and bearing element caused by the manufacture, be compensated for. Because of this, a flat joining surface is created, which makes possible a highly precise positioning of the laminated rotor core on the rotor shaft.

The use of the support body that is substantial for the invention additionally makes possible configuring the position of a welded connection or weld seam between tubular body and bearing element generated for example by means of laser welding so that the necessary radial position of the welded connection or weld seam required for a simplified manufacturing process becomes realisable and can also be easily reworked. In particular, because of the provision of the said support bodies, the provision of combined axial and radial grinding wheels for reworking can be omitted, which simplifies manufacturing the rotor shaft.

In detail, a rotor shaft according to the invention includes a hollow-cylindrically formed tubular body surrounding a tubular body interior. The tubular body is designed open at least on one of its two end sides. The end-side opening formed by the tubular body on this end-side is closed by means of a bearing element that is non-rotatably connected to the tubular body. According to the invention, the rotor shaft includes an annular support body, in particular a support ring, which is arranged radially on the outer circumferential side of the tubular body and is non-rotatably connected to the same. The support body supports itself axially on a front side of the bearing element facing the tubular body.

Practically, the bearing element can be connected to the tubular body by means of a press fit. In this way, a precise non-positive connection of the bearing element with the tubular body is realised. The support body joined with a greater overlap supports the joining fit of the pressed-in bearing element and thus leads to a greater torque transmission on the joining seat of the same. Conversely, this in turn allows a reduction of the joining length of the bearing element.

In a preferred embodiment, the bearing element is partially inserted into the front-side opening, preferentially pressed in. In this way, the bearing element can be fixed to the tubular body in a particularly stable manner.

According to an advantageous further development of the embodiment explained above, the bearing element comprises a first axial element portion, which is inserted into the front-side opening. The first axial element portion, axially away from the tubular body, merges into a second axial element portion arranged outside the tubular body interior, which radially protrudes over the first element portion and the tubular body radially to the outside. In this further development, the support body supports itself radially on the first element portion and axially on the second element portion of the bearing element. An end portion of the tubular body facing the bearing element and including the front side supports itself in this further development radially on the first element portion and axially on the second element portion of the bearing element.

Particularly preferably, a radial clearance can be present between the support body and the tubular body. Alternatively to this, the support body however can also be connected by means of a press fit to the tubular body and non-rotatably mounted on the same. In both variants, the support body can be held in position by means of the rotor sheets joined on the tubular body of the rotor equipped with the rotor shaft according to the invention.

In another preferred embodiment, the bearing element extends the tubular body axially. In this embodiment, the bearing element is integrally connected to the front side of the tubular body by means of a welded connection.

According to an advantageous further development of the embodiment explained above, the bearing element comprises a first axial element portion which supports itself on the tubular body and is integrally connected to the tubular body by means of the welded connection. The first axial element portion merges axially away from the tubular body into a second axial element portion arranged outside the tubular interior, which protrudes over the first element portion and the tubular body radially to the outside. The second element portion can close the front-side opening of the tubular body.

In this further development, the support body supports itself radially both on the tubular body and also on the first element portion and of the bearing element axially on the second element portion of the bearing element. An end portion of the tubular body facing the bearing element and including the first front-side supports itself axially on the second element portion 6b of the bearing element.

Practically, the tubular body can comprise a chamfer in a longitudinal section along the axial direction radially outside and/or radially inside.

Particularly preferably, a recess can be formed at a transition from the first to the second element portion of the bearing element. This recess ensures a flat bearing of the tubular body on the bearing element. In addition, the said recess can also be used for at least partially receiving the weld seam of the welded connection mentioned above.

In another preferred embodiment, at least one cooling channel for being flowed through by a cooling medium can be formed in the support body. By means of the cooling medium, heat generated in the laminated rotor core or in the rotor sheets of the same during the operation of the rotor can be dissipated. In particular, the cooling channel can be used for discharging cooling medium flowing through the tubular body in that a fluidic connection between the tubular body interior delimited by the tubular body and the at least one cooling channel formed in the support body, the formation of such a cooling channel in the bearing element can be omitted by providing such a cooling channel in the support body, which results in cost advantages in the manufacture of the bearing element and thus the entire rotor shaft.

Further, the invention relates to a rotor for an electric machine. The rotor includes a rotor shaft according to the invention introduced above, so that the advantages of the rotor shaft according to the invention explained above apply also to the rotor. On the tubular body of the rotor shaft, a laminated rotor core with multiple rotor sheets arranged axially next to one another is non-rotatably connected to the tubular body.

According to an advantageous further development of the rotor according to the invention, at least one electrically energizable rotor coil for generating a magnetic rotor field is arranged, in particular mounted on the laminated rotor core.

In addition, the invention relates to an electric machine having a rotor according to the invention introduced above. The advantages of the rotor according to the invention or the rotor shaft according to the invention explained above thus apply also to the electric machine according to the invention. In addition to the rotor, the machine according to the invention includes a stator on which the rotor is rotatably mounted by means of the two bearing elements of the shaft. By way of magnetic interaction between the stator and the rotor, the rotor can be driven, i.e. set into rotary motion. In this case, the electric machine is an electric motor. However, it is also conceivable that the electric machine is operated as electric generator. In this case, the rotor is set into rotary motion by means of an electric drive system and in this way, by magnetic interaction between rotor and stator, an electrical voltage induced in the stator.

Further important features and advantages of the invention are obtained from the subclaims, from the drawings and from the associated figure description by way of the drawings.

It is to be understood that the features mentioned above and still to be explained in the following cannot only be used in the respective combination stated, but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically:

FIG. 1 an example of a rotor shaft according to the invention in a longitudinal section, in which the bearing element is inserted into the front-side opening of the tubular body,

FIG. 2 a variant of the example of FIG. 1 in which the bearing element axially extends the tubular body and lies against the front side of the tubular body.

### DETAILED DESCRIPTION

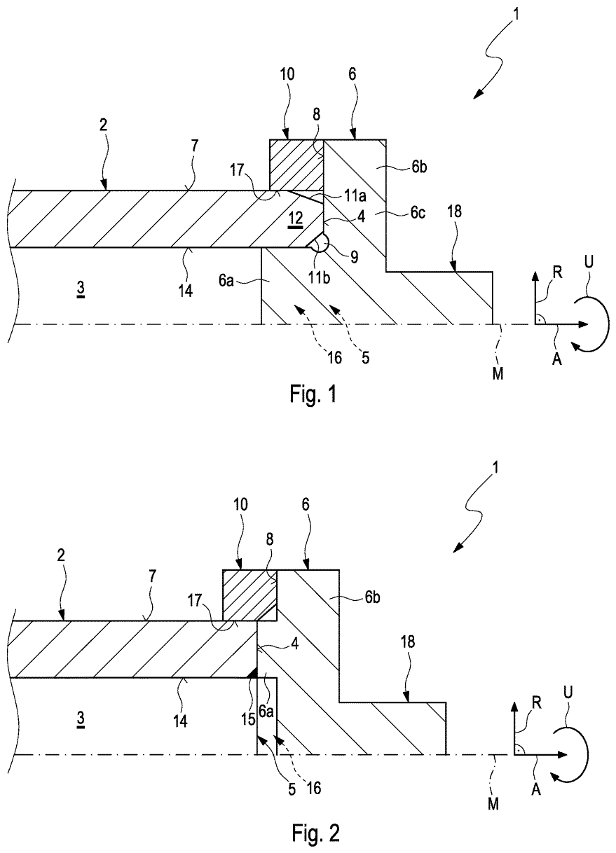

FIG. 1 shows in a longitudinal section an example of a rotor shaft 1 according to the invention in a part representation. The rotor shaft 1 includes a hollow-cylindrically formed tubular body 2 partially surrounding a tubular body interior 3. The tubular body 2 has a centre longitudinal axis M, which extends along an axial direction A. A radial direction R extends perpendicularly to the axial direction A away from the centre longitudinal axis M. A circumferential direction U runs perpendicularly to the axial direction A and also perpendicularly to the radial direction R round about the centre longitudinal axis M.

On one of its two front sides 4—the axially opposite other front side is not shown in FIG. 1—the tubular body 2 is designed open. The front-side opening 5 formed by the tubular body 2 on the said front side 4 is closed by means of a bearing element 6 that is non-rotatably connected to the tubular body 2.

The bearing element 6 serves for rotatably mounting the rotor shaft 1, for example on a housing that is not shown in more detail or on a stator of a rotor using the rotor shaft 1. According to FIG. 1, the rotor shaft 1 includes an annular support body 10 in the form of a support ring. The support body 10 is arranged on the outer circumferential side 7 of the tubular body 2 and non-rotatably connected to the same. The tubular body 2 engages through a passage opening 16 that is circumferentially completely enclosed by the annular support body 10. There, an interior circumferential side 17 of the support body 10 lies against the outer circumferential side 7 of the tubular body 2.

As is noticeable in FIG. 1, the support body 10 supports itself axially on a front side 8 of the bearing element 6 facing the tubular body 2. The bearing element 6 can be connected to the tubular body 2 by means of a press fit. In particular, the bearing element 6 can be partially inserted and also pressed into the front-side opening 5.

In the example of FIG. 1, the bearing element 6 comprises a first axial element portion 6a, which is inserted into the front-side opening 5. The first axial element portion 6a merges along the axial direction A away from the tubular body 2 into a second axial element portion 6b arranged outside the tubular body interior, which protrudes over the first element portion 6a and the tubular body 2 radially to the outside. In the radial direction R, the support body 10 supports itself on the tubular body 2 and in the axial direction A on the second element portion 6b of the bearing element 6. An end portion 12 of the tubular body 2 facing the bearing element 6 and including the front side 4 supports itself radially on the first element portion 6a and axially on the second element portion 6b of the bearing element 6.

As is additionally illustrated by FIG. 1, a recess 9 can be formed at a transition 6c from the first axial element portion Ga to the second axial element portion 6b.

Apart from this, the tubular body 2, as in FIG. 1, can comprise a chamfer 11a, 11b in a longitudinal section along the axial direction radially outside—that is at the transition of the outer circumferential side 7 of the tubular body 2 to the front side 4—and also radially inside—that is at the transition of an inner circumferential side 14 of the tubular body 2 to the front side 4.

FIG. 2 shows a variant of the example of FIG. 1. The example of FIG. 2 differs from that of FIG. 1 in that the bearing element 6 is not inserted into the front-side opening 5 of the tubular body 2 but lies against the front side 4 of the tubular body 2 and is connected to the same. Thus, the bearing element 6 extends the tubular body 2 in the axial direction A. In the example, the bearing element 6 is integrally connected to the front side 4 of the tubular body by means of a welded connection 15.

In the example of FIG. 2, the bearing element 6 also comprises a first axial element portion 6a which however—in contrast with the example of FIG. 1—supports itself axially on the tubular body 2 and is integrally connected to the tubular body 2 by means of the said welded connection 15. The first axial element portion 6a merges axially away from the tubular body 2 into a second axial element portion 6b arranged outside the tubular body interior 3, which protrudes over the first element portion 6a and the tubular body 2 radially to the outside. Further, the support body 10 supports itself radially on the first element portion 6a and on the tubular body 2 and axially on the second element portion 6b of the bearing element 6. The end portion 8 of the tubular body 2 including the front side 4 facing the bearing element 6 supports itself axially on the second element portion 6b of the bearing element 6.

Both in the example of FIG. 1 and also in the example of FIG. 2, a radial clearance can be formed between the support body 10 and the tubular body 2. Likewise, both in the example of FIG. 1 and also in the example of FIG. 2, the support body 10 can be connected to the tubular body 2 by means of a press fit.

1. A rotor shaft for a rotor of an electric machine, comprising:
a hollow-cylindrically formed tubular body surrounding a tubular body interior that is open at least on one of its two front sides, wherein a front-side opening defined by the tubular body on the at least one front side is closed via a bearing element that is non-rotatably connected to the tubular body; and
an annular support body that is arranged radially on an outer circumferential side of the tubular body and non-rotatably connected to the tubular body and supports itself axially on a front side of the bearing element facing the tubular body.

2. The rotor shaft according to claim 1, wherein the bearing element is connected to the tubular body via a press fit.

3. The rotor shaft according to claim 1, wherein the bearing element is partially inserted into the front-side opening.

4. The rotor shaft according to claim 3, wherein:
the bearing element comprises a first axial element portion that is inserted into the front-side opening, and merges away from the tubular body into a second axial element portion arranged outside the tubular body interior, the second element portion protrudes over the first element portion and the tubular body radially to the outside,
the support body supports itself radially on the first element portion and axially on the second element portion of the bearing element, and
an end portion of the tubular body facing the bearing element and including the at least one front side supports itself radially on the first element portion and axially on the second element portion of the bearing element.

5. The rotor shaft according to claim 1, wherein on of:
between the support body and the tubular body a radial clearance is present; and
the support body is connected to the tubular body via a press fit.

6. The rotor shaft according to claim 1, wherein:
the bearing element axially extends the tubular body, and
the bearing element is integrally connected to the at least one front side of the tubular body via a welded connection.

7. The rotor shaft according to claim 6, wherein:
the bearing element comprises a first axial element portion that supports itself on the tubular body and is integrally connected to the tubular body via the welded connection and away from the tubular body merges into a second axial element portion arranged outside the tubular body interior, the second element portion protrudes over the first element portion and the tubular body radially to the outside,
the support body supports itself radially on the first element portion and axially on the second element portion of the bearing element,
an end portion of the tubular body facing the bearing element and including the at least one front side supports itself axially on the second element portion of the bearing element.

8. The rotor shaft according to claim 7, wherein the welded connection is provided between the tubular body and the second element portion of the bearing element.

9. The rotor shaft according to claim 1, wherein the tubular body, in an axial longitudinal section, comprises a chamfer at least one of radially outside and radially inside.

10. The rotor shaft according to claim 4, wherein at a transition from the first element portion to the second element portion a recess is provided.

11. The rotor shaft according to claim 1, wherein in the support body at least one cooling channel for being flowed through by a cooling medium is provided.

12. A rotor for an electric machine,
a rotor shaft, the rotor shaft including:
a hollow-cylindrical tubular body surrounding a tubular body interior that is open at least on one of its two front sides, wherein a front-side opening defined by the tubular body on the at least one front side is closed via a bearing element that is non-rotatably connected to the tubular body; and
an annular support body that is arranged radially on an outer circumferential side of the tubular body and non-rotatably connected to the tubular body and supports itself axially on a front side of the bearing element facing the tubular body,
a laminated rotor core having multiple rotor sheets arranged axially next to one another provided on the tubular body and non-rotatably connected to the tubular body.

13. The rotor according to claim 12, wherein on the laminated rotor core at least one electrically energizable rotor coil for generating a magnetic rotor field is arranged.

14. An electric machine, comprising:
a rotor, the rotor including:
a rotor shaft including:
a hollow-cylindrical tubular body surrounding a tubular body interior that is open at least on one of its two front sides, wherein a front-side opening defined by the tubular body on the at least one front side is closed via a bearing element that is non-rotatably connected to the tubular body; and
an annular support body that is arranged radially on an outer circumferential side of the tubular body and non-rotatably connected to the tubular body and supports itself axially on a front side of the bearing element facing the tubular body,
a laminated rotor core having multiple rotor sheets arranged axially next to one another provided on the tubular body and non-rotatably connected to the tubular body, and
a stator, on which the rotor is rotatably mounted.

15. The electric machine according to claim 14, wherein the bearing element comprises a first axial element portion that supports itself on the tubular body and is connected to the tubular body via a welded connection and away from the tubular body merges into a second axial element portion arranged outside the tubular body interior, the second element portion protrudes over the first element portion and the tubular body radially to the outside.

16. The electric machine according to claim 15, wherein:
the support body supports itself radially on the first element portion and axially on the second element portion of the bearing element, and
an end portion of the tubular body facing away from the bearing element and including the at least one front side supports itself axially on the second element portion of the bearing element.

17. The electric machine according to claim 16, wherein a recess is provided at a transition from the first element portion to the second element portion.

18. The rotor according to claim 12, wherein the bearing element comprises a first axial element portion inserted into the front-side opening, and merges away from the tubular body into a second axial element portion arranged outside the tubular body interior, the second element portion protruding over the first element portion and the tubular body radially to the outside.

19. The rotor according to claim 18, wherein:
the support body supports itself radially on the first element portion and axially on the second element portion of the bearing element, and
an end portion of the tubular body facing away the bearing element and including the at least one front side supports itself radially on the first element portion and axially on the second element portion of the bearing element.

20. The rotor according to claim 12, wherein the tubular body, in an axial longitudinal section, comprises a chamfer at least one of radially outside and radially inside.
